(19) United States
(12) Patent Application Publication
(10) Pub. No.: US 2009/0214006 A1
(43) Pub. Date: Aug. 27, 2009

(54) SYSTEM AND METHOD FOR PROVIDING ENHANCED VOICE MESSAGING SERVICES

(75) Inventors: Fredrick L. Campbell, Mill Valley, CA (US); Jean L. Barkocy, San Francisco, CA (US); Anthony Levitan, Palo Alto, CA (US); Sriraman Srinivasan, San Francisco, CA (US)

Correspondence Address: MYERS WOLIN, LLC, 100 HEADQUARTERS PLAZA, North Tower, 6th Floor, MORRISTOWN, NJ, 07960-6834, US

(73) Assignee: Lexy, Inc., San Francisco, CA (US)

(21) Appl. No.: 12/273,088

(22) Filed: Nov. 18, 2008

Related U.S. Application Data
(60) Provisional application No. 60/996,447, filed on Nov. 19, 2007.

(51) Int. Cl. H04M 11/00

(52) U.S. Cl. 379/88.13

(57) ABSTRACT

A system and method for providing enhanced audio messaging services. The system comprises a voice gateway for interfacing with a plurality of telephone devices, a voice messaging server (VMS) and a content server that together enable the execution of the enhanced messaging services. The system further includes a metadata database for maintaining metadata associated with users, messages and content items. The enhanced audio messaging services include, but are not limited to, phone-to-phone sharing of audio content, phone-to-phone sharing of broadcasted radio content, web-to-phone audio content sharing, phone-to-web content sharing, interactive group discussions, and dynamic asynchronous audio messaging.

### CROSS-REFERENCE TO RELATED-APPLICATIONS

This application claims the benefit of U.S. Provisional Application No. 60/996,447 filed on Nov. 19, 2007, the contents of which are herein incorporated by reference.

### FIELD OF THE INVENTION

The present invention generally relates to voice messaging systems.

### BACKGROUND OF THE INVENTION

Several technologies enable immediate messaging over telecommunication networks. A prime example is voice-mail systems. These systems forward a call to a voice-mail answering machine that enables the caller to leave a voice message in a case that the called party does not answer. Another way for leaving a voice message is by dialing directly to the voice-mail system. When a voice message is left for a target user, the user is notified using, for example, a short message service (SMS) message, an icon on the user's handset, or a light indicator on a wire-line telephone. Voice messages can be retrieved by calling the voice-mail system, hearing the interactive voice response (IVR) and following the instructions of the IVR.

Another voice messaging technique is known as a multi media service (MMS). In this service, a user records a message on an MMS supported telephone and then sends the message, as a SMS-like message, to another user that has a MMS supported telephone. The message is stored within the target user's telephone and can be played. The MMS message may include text, images or pictures in addition to a recorded voice message. This service requires a MMS supported networks (e.g., 3G cellular technologies) as well as MMS enabled telephones. MMS messages can be sent simultaneously to a group of users. A user can reply to a received message by recording and sending a message to the sender.

Another immediate voice messaging technique is a voice paging, which is based on calling a certain phone number and then entering a subscriber identification number (IDN) followed by relaying of the voice message. The message is sent to a voice-paging device.

Existing techniques do not generally provide instant voice messaging with almost real-time experience of voice communication for telephony and voice over internet protocol (VoIP) systems both wired and cellular. For example, existing consumer voice messaging services provided by the carriers cannot render a conversation thread. Furthermore, all existing services are limited to a voice recorded by a sender and cannot provide free-form sharing of audio content in addition to the recorded message.

Another disadvantage of existing techniques is that they require dedicated client software on the end-user telephones in order to enable some of the voice messaging services, while other services are limited to certain network carriers. In addition, voice messages are either stored in the users' telephones or in storage devices of voice-mail systems. In both cases, the number and size of voice messages that can be stored and later accessed by users are limited. In all cases, audio interactions are limited to voice messaging.

Therefore, it would be advantageous to provide a solution that overcomes the disadvantages of voice messaging techniques that exist in the prior art.

### SUMMARY

Certain embodiments of the invention include a system and method for providing enhanced audio messaging services. The system comprises a voice gateway for interfacing with a plurality of telephone devices, a voice messaging server (VMS) and a content server that together enable the execution of the enhanced messaging services. The system further comprises a metadata database for maintaining metadata associated with users, messages and content items. In certain exemplary embodiments the enhanced audio messaging services include phone-to-phone sharing of audio content, phone-to-phone sharing of broadcasted radio content, web-to-phone audio content sharing, phone-to-web content sharing, interactive group discussions, dynamic asynchronous audio messaging, and the like.

### BRIEF DESCRIPTION OF THE DRAWINGS

FIG. 1 is a system for providing enhanced audio messaging services implemented in accordance with an embodiment of the invention.

FIG. 2 is a diagram describing the operation of the phone-to-phone content sharing implemented in accordance with an embodiment of the invention.

### DETAILED DESCRIPTION OF THE PREFERRED EMBODIMENTS

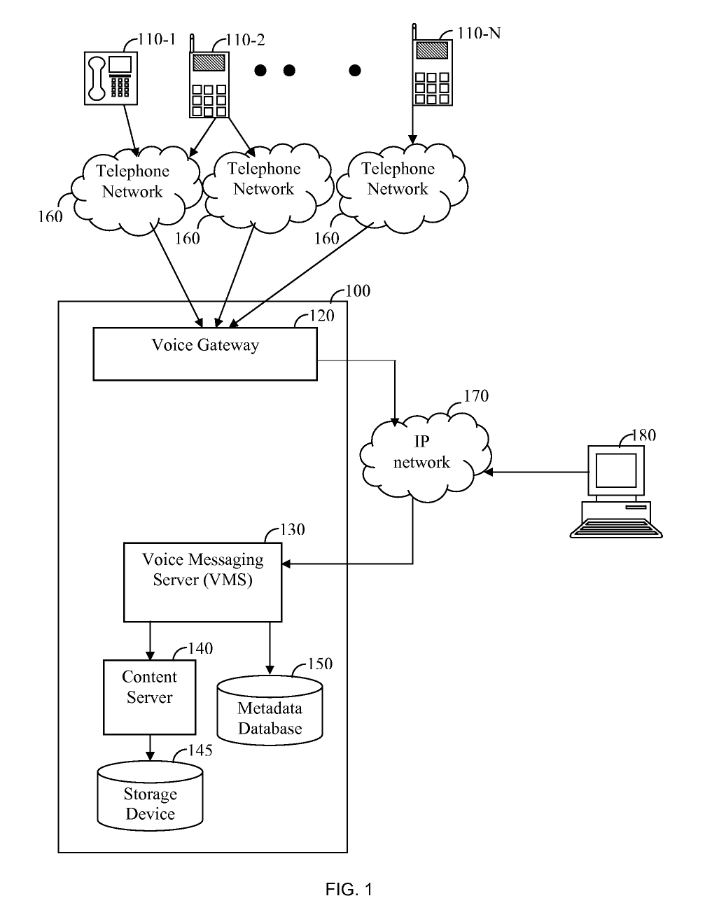

FIG. 1 shows a non-limiting and exemplary system 100 for providing enhanced audio messaging services implemented in accordance with an embodiment of the invention. The enhanced audio messaging services provided by the system 100 include, but are not limited to, phone-to-phone sharing of audio content, phone-to-phone sharing of broadcasted radio content, web-to-phone audio content sharing, phone-to-web content sharing, interactive group discussions, dynamic asynchronous audio messaging, and so on. The system 100 comprises a voice gateway 120, a voice messaging server (VMS) 130, a content server 140 coupled to a storage device 145, and a metadata database 150.

Users of the system 100 may communicate with each other using a plurality of telephone devices 110-1 through 110-N that include, but are not limited to, a mobile telephone, a wired telephone, a smart telephone, a personal digital assistant (PDA), a soft telephone, and the like. The telephone devices 110-1 to 110-N are standard and may belong to different network carriers of telephone networks 160. The networks 160 may include, for example, a cellular network, a public switched telephone network (PSTN), a VoIP network, or any combination thereof. Each telephone device 110 is standard equipment which does not require any dedicated hardware, software, firmware, or any combination thereof for executing the services provided by the system 100.

The voice gateway 120 acts as an interface between the VMS server 130 and telephone networks 160. The telephone devices 110-1 to 110-N interface with the voice gateway 120 through a voice channel. The voice gateway 120 captures voice signals received during a phone call, converts them to an audio file and sends the file to the VMS 130. The audio files are sent to the VMS 130 over an IP network 170 using, for example, a hypertext transfer protocol (HTTP). The VMS 130 can also communicate with users of the telephone devices 110-1 to 110-N by providing the voice gateway 120 with voice web pages (e.g., Voice-XML). The voice gateway 120 uses these voice web pages to interface with telephone devices 110.

The VMS 130 executes the tasks that enable the enhanced voice messaging services provided by the invention. Generally, these tasks include recording, i.e., entering audio content to the system, listening to stored content, and sharing content. These tasks will be described in greater detail below. Users can access the VMS 130 using a web site 180. This allows users the creation and/or uploading of content to the system 100 and listening or sharing content stored in the system 100.

The content server 140 maintains all voice and audio content uploaded or recorded by users. Specifically, the content server 140 maintains voice messages recorded by users, audio files uploaded by users (either through the telephone devices 110-1 to 110-N or web-site 180), digitized audio content, including broadcasted radio programs, voice conversations, combination of voice and non-voice conversations, and so on. Each item maintained by the content server 140 has a unique identification (ID) number. Items may be categorized according to users in private and public directories. Items maintained by the content server 140 are physically resided in the storage device 145 in a format of an audio file, such as WAV, MP3, AIFF, MMW, AU, VOX, and the like.

The metadata database 150 maintains all information associated with content items stored in the storage device 145. This includes a pointer to the physical location of the item, a timestamp, an identification (ID) number of the sender, an ID of recipient, and so on. The metadata database 150 also includes phone books of users.

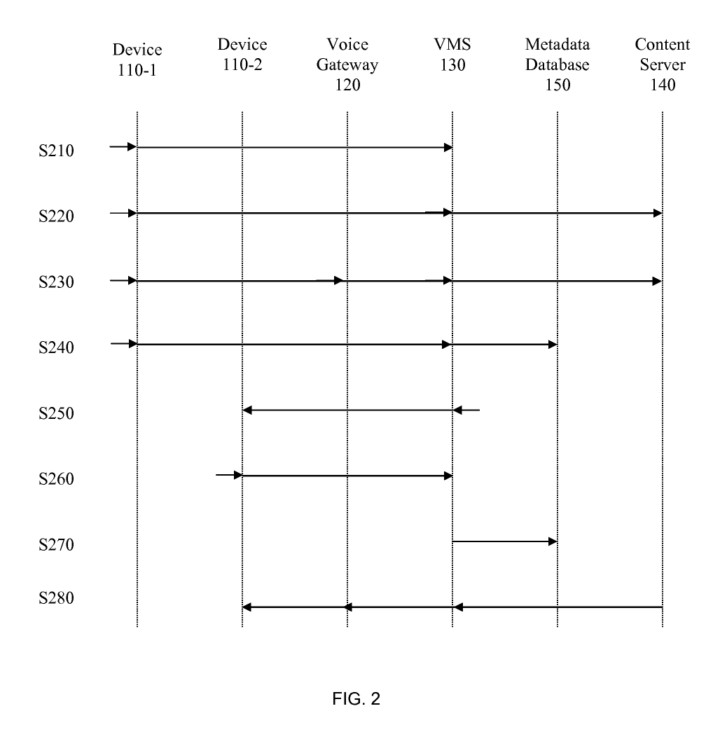

FIG. 2 shows an exemplary and non-limiting diagram describing the operation of the phone-to-phone content sharing implemented in accordance with an embodiment of the invention. This service allows users of the telephone devices 110-1 to 110-N to share audio content with each other. The shared content may include audio content, voice messages, or combination thereof.

Users can share content that resides in the content server 140. In order to load content to the server 140, a user calls the system 100 using a telephone device 110, and then creates a content item. The content item may be created by performing any of the following speaking to the telephone device 110, using the telephone device 110 to create an audio file, or playing an audio file stored in the content server. The VMS 130 prompts users on how to add and where to save content items. Any voice signals generated during the call with the VMS 130 is converted to an audio file and sent to the VMS 130 and later saved in the content server 140. Alternatively, the users may access the VMS 130 through a web-site 180 and upload audio files created and/or stored in their personal computers, or upload audio files accessible on the World Wide Web. Uploaded files are also saved in the content server 140. Each item loaded to content server 140 creates an entry in the database 150 that may include a user ID, an upload time, a user-generated audio name or subject line, and a pointer to the actual file resided in the storage device 145. The user may also share the uploaded content immediately with other users while he browsers the web-site.

At S210 the user of a telephone device 110-1 dials to the VMS 130 which then answers the call and plays a pre-recorded menu of voice messaging services provided by the VMS 130. The VMS 130 uses a caller ID, a password, or a PIN to recognize users and redirect them into their personal account that contains their messages and personalized directory, including, but not limited to, a phonebook and saved content. Upon selection of the phone-to-phone sharing service, at S220, the VMS 130 prompts the user to select a content item or items to share, by browsing through his personalized directory or public directories, or user predefined audio program play-lists. Thereafter, the user is prompted to create a voice message for the selected item(s). If the user decided to do so, at S230, the recorded message is converted to an audio file and saved in the content server 140 as described in detail earlier. At S240, the user is prompted to select a recipient (in this example a user of telephone device 110-2) or group of recipients with whom the user wishes to share the audio content (i.e., the selected item with or without a voice message). The user selects the recipients from a phone book saved in the metadata database 150. The user may also add recipients to the database 150. All users' instructions to the system 100 are received either through voice or keypad inputs.

Once all selections are entered by the user of the telephone device 110-1, the VMS 130 creates a new content item that includes the selected audio content and the recorded message, saves it in the content server 140 and links associated metadata to that item. Thereafter, at S250, the VMS 130 notifies the user of the telephone device 110-2 using a SMS and/or email message, or dialing the recipient directly, that a new content item is waiting. The SMS may be generated automatically by the VMS 130 or manually entered by the user of telephone device 110-1. The notification message includes at least a telephone number that the user has to dial in order to listen to the new content item. At S260 the user using, for example, a telephone device 110-2 dials the number designated in the message. At S270, using a caller ID, a password, or a PIN, the VMS 130 identifies the user, searches in the metadata database 150 for a metadata entry that is associated with caller ID. The content item waiting for the user is retrieved from the server 140 using a pointer saved in the respective metadata entry. At S280, the audio content is streamed and played through the voice gateway 120. While listening to audio content the user can skip forward or backward, obtain an audio listing of all group message participants, speed up the rate of audio playback, and the like. If the message includes a list of content items the user can skip forward and backward within the list. The user of a telephone device 110-2 may further reply, forward or save the audio message, or any portion of the audio message. The user may reply with a recorder voice message and/or a content item using the process described above.

It should be apparent to a one or ordinary skill in the art that the method enabling the phone-to-phone content sharing does not transmit the content item as a file to recipient's telephone device 110-2, but rather the user listens to the content stored in system 100.

In another embodiment of the invention users can share audio content of broadcast radio programs. According to this embodiment radio programs are digitized and saved as audio programming portions, such as songs, news clips, D.J. rifts, etc., in the content server 140. Users can call system 100, navigate the taxonomy of the radio programs and choose a particular programming portion or a program to listen to or to share with other users. The sharing of radio content is performed as the process for sharing content items described in detail above.

In accordance with another embodiment the system 100 is used to conduct an asynchronous group or one-on-one conversations. A conversation is a thread of audio messages, i.e., a message that include voice message with an attached audio content. A user who was invited to the conversation can listen to the audio messages, navigate among parts of the audio conversation, and reply, forward, or save each of the messages in the conversation by creating his audio message.

A user of a telephone device 110 initiates a conversation by dialing to the system 100, designates a recipient or group of recipients of the message, records his voice message and selects a content item to attach to the voice message. The VMS 130 creates a new audio message and saves it in the content server 140. Then, the VMS 130 notifies the recipients of a new audio message added to the conversation. Each recipient may call-in the VMS 130 and listen to the new message as described in detail earlier. The recipient may reply or forward all or a portion of the conversation with a new audio message.

It should be apparent to one of ordinary skill in the art that the various components of the system 100 and processes described herein can be implemented in hardware, software, firmware, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

While the invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What we claim is:

1. A system for providing enhanced audio messaging services, comprising:
a voice gateway for interfacing with at least a network for interfacing with a plurality of telephone devices;
a voice messaging server (VMS) connected to the voice gateway for at least processing audio messages; and
a content server connected to the VMS for maintaining audio content of the audio messages.

2. The system of claim 1, further comprising:
a metadata server connected to the VMS for maintaining at least one of: an identification of an audio content and an identification of each telephone device of the plurality of telephone devices.

3. The system of claim 1, further comprising:
a web connection enabling access to audio messages.

4. The system of claim 1, wherein the processing of audio messages further comprising: recording an audio message, playing back an audio message, and sharing an audio message.

5. The system of claim 1, wherein the enhanced audio messaging services include at least: a web-to-phone audio content sharing service, a phone-to-web content sharing service, a phone-to-phone sharing of audio content service, a phone-to-phone sharing of broadcasted radio content service, and a interactive group discussions service, and a dynamic asynchronous audio messaging service.

6. The system of claim 5, wherein the dynamic asynchronous audio messaging enables a user to append a voice message to an existing voice message stored in the system.

7. The system of claim 4, wherein recoding the audio message further comprising:
recording a first audio message from a first user listening to a second audio message received from a second user; and
forwarding the audio message to the second user.

8. The system of claim 1, further comprising:
a data storage for storing the audio message.

9. The system of claim 1, wherein the audio message is stored in an audio file format, wherein the audio file format is one of: WAV, MP3, AIFF, MMW, AU, and VOX.

10. The system of claim 1, wherein the network comprises at least one of: a cellular network, a public switched telephone network (PSTN), and a voice over internet protocol (VoIP network).

11. The system of claim 1, further enabled with short message system (SMS) capabilities, wherein an SMS is generated to alert of an existence of content.

12. The system of claim 11, wherein said SMS is at least one of: a system generated SMS and a user generated SMS.

13. A method for providing enhanced audio messaging services, comprising:
recording a first audio message from a first telephone device intended to a second telephone device;
storing the first audio message in an audio content storage;
storing metadata associated with the first audio message;
sending a notification to the second telephone device of the existence of the first audio message;
receiving a request to listen to the first audio message from the second telephone device; and
streaming the first audio message to the second telephone device.

14. The method of claim 13, further comprising:
enabling the second telephone device to record a second audio message;
storing the second audio message in the audio content storage;
storing metadata associated with the second audio message; and
sending a notification to the first telephone device of the existence of the response audio message based on the stored metadata.

15. The method of claim 13, wherein said metadata includes at least one of: information respective of the first telephone device, information respective of the second telephone device.

16. The method of claim 13, further comprising:
enabling the sharing of the first audio message with at least another telephone device.

17. The method of claim 13, wherein the second audio message is appended to said first audio message.

18. The method of claim 17, wherein appending the second audio message is to any point within the first audio message.

19. The method of claim 17, further comprising:
accessing the audio content storage by a web-based application.

20. The method of claim 13, wherein an audio message is comprised from a plurality of audio messages, wherein a file format of an audio message is one of: WAV, MP3, AIFF, MMW, AU, and VOX.

21. The method of claim 13, wherein the second telephone device comprises a group of telephone devices of a group of recipients.

22. The method of claim 13, wherein said notification is a short message system (SMS).

23. The method of claim 22, further comprising at least one of:
sending a canned SMS; and
sending a user entered SMS.

24. The method of claim 13, wherein the enhanced audio messaging services comprise at least: a web-to-phone audio content sharing service, a phone-to-web content sharing service, a phone-to-phone sharing of audio content service, a phone-to-phone sharing of broadcasted radio content service, and an interactive group discussions service, and a dynamic asynchronous audio messaging service.

25. A computer readable medium having stored thereon computer executable code causing a processor to execute a process of providing enhanced audio messaging services, comprising:
recording a first audio message from a first telephone device intended to a second telephone device;
storing the first audio message in an audio content storage;
storing metadata associated with the first audio message;
sending a notification to the second telephone device of the existence of the first audio message;
receiving a request to listen to the first audio message from the second telephone device; and
streaming the first audio message to the second telephone device.

26. The computer readable medium of claim 25, further comprising:
enabling the second telephone device to record a second audio message;
storing the second audio message in the audio content storage;
storing metadata associated with the second audio message; and
sending a notification to the first telephone device of the existence of the response audio message based on the stored metadata.

27. The computer readable medium of claim 25, wherein the enhanced audio messaging services comprise at least: a web-to-phone audio content sharing service, a phone-to-web content sharing service, a phone-to-phone sharing of audio content service, a phone-to-phone sharing of broadcasted radio content service, and an interactive group discussions service, and a dynamic asynchronous audio messaging service.
